(19) United States
(12) Patent Application Publication
(10) Pub. No.: US 2007/0296571 A1
(43) Pub. Date: Dec. 27, 2007

(54) MOTION SENSING IN A WIRELESS RF NETWORK

(76) Inventor: Paul T. Kolen, Encinitas, CA (US)

Correspondence Address: FISH & RICHARDSON, PC, P.O. BOX 1022, MINNEAPOLIS, MN, 55440-1022, US

(21) Appl. No.: 11/762,686

(22) Filed: Jun. 13, 2007

Related U.S. Application Data
(60) Provisional application No. 60/813,482, filed on Jun. 13, 2006.

(51) Int. Cl. G08B 1/08; G08B 23/00

(52) U.S. Cl. 340/539.11; 340/573.1

(57) ABSTRACT

Techniques and systems that monitor motion of a person or object and wirelessly communicate the motion data of the person through a network of wireless communication transceiver nodes to a central monitor station. An abnormal state of motion of the person or object can be detected based on the motion data and an alert signal can be generated when an abnormal condition of the person or object occurs. Other parameters of a person or object may also be measured and transmitted to the central monitor station, such as the heart beat and body temperature of the person or the orientation or dynamic motion of an object.

### PRIORITY CLAIMS

This application claims the benefits and priority of U.S. Provisional Application No. 60/813,482 entitled “MOTION SENSING IN A WIRELESS RF NETWORK” and filed Jun. 13, 2006, the entire disclosure of which is incorporated by reference as part of the specification of this application.

### BACKGROUND

This application relates to motion sensing.

Motion of an object can be monitored using various sensors. For example, an accelerometer can be attached to the object to be monitored to measure the acceleration of the object. For another example, a gyroscope sensor can be attached to the object to measure the orientation of the object. A tri-axial accelerometer that measures acceleration in three directions (e.g., three one-dimensional accelerometers in three orthogonal directions x, y and z) and a gyroscope in three orthogonal directions can be combined to construct an inertial measurement unit (IMU) capable of determining the change in the spatial orientation and the linear translation of the object relative to a fixed external coordinate system. A tri-axial magnetometer may be added to this IMU system to measure the orientation of the IMU relative to the earth magnetic field and thus determine the absolute orientation of the IMU.

### SUMMARY

This application describes techniques and systems that monitor motion of a person or object and wirelessly communicate the motion data of the person or object through a network of wireless communication transceiver nodes to a central monitor station. An abnormal state of motion of the person or object can be detected based on the motion data and an alert signal can be generated when an abnormal condition of the person or object occurs. Other parameters of a person or object may also be measured and transmitted to the central monitor station, such as the heart beat and body temperature of the person or a change in orientation or position of the object. Hospitals, senior nursing homes, child care facilities and other facilities may implement such motion sensing systems to monitor persons under the care and the motion and other data may be used to facilitate the care and assistance to a person.

These and other examples, implementations, and variations are described in greater detail in the attached drawings, the detailed description and the claims.

### BRIEF DESCRIPTION OF THE DRAWINGS

FIG. 1 shows an example of a motion sensing system with a central monitor and a network of wireless transceiver nodes.

FIG. 2A shows an example sensor module used in the system in FIG. 1.

FIG. 2B shows an example wireless transceiver node in the system in FIG. 1.

FIG. 2C shows an example battery power supply for a sensor module in the system in FIG. 1.

FIG. 3 shows another example sensor module used in the system in FIG. 1.

### DETAILED DESCRIPTION

The techniques and systems for monitoring motion and other parameters of a person or object can use a sensor module that includes a sensor for sending and obtaining data of the person or object and an RF transceiver for communicating the data to a destination. The sensor module is attached to the person or object to be monitored. The sensor module can include a digital circuit to process and package the sensor data for wireless transmission and to control wireless communications to and from the RF transceiver. A second or more sensors may be included in the sensor module for obtaining information associated with the person or object. In some implementations, two or more sensor modules may be attached to the same person or object and two different sensor modules may be used to obtain different data of the person or object.

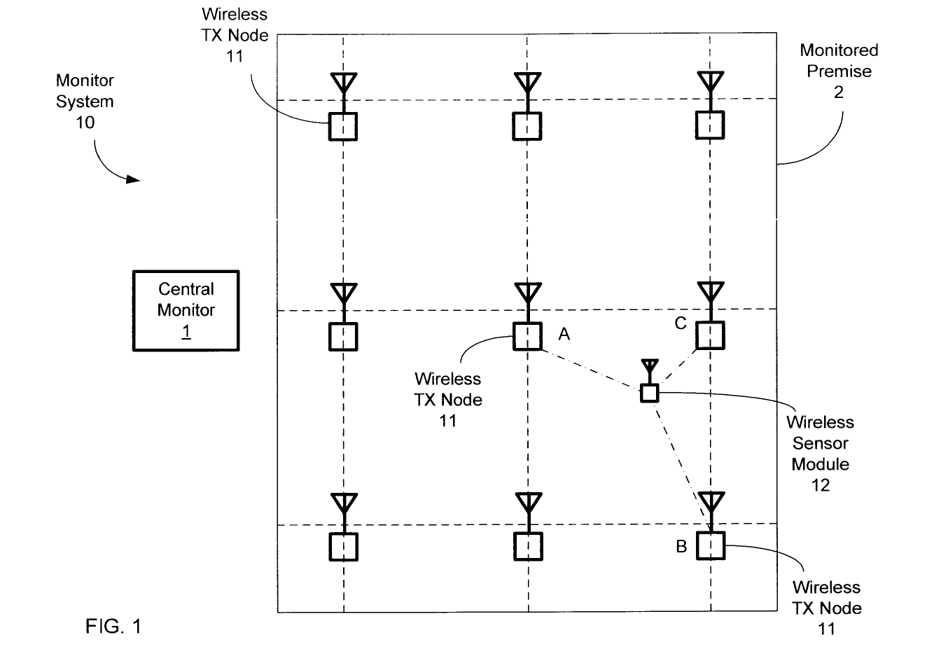

FIG. 1 shows an example of a sensor module 12 placed in a motion sensing system 10 with a central monitor 1 and a network of wireless transceiver nodes 11. The sensor module 12 is attached to the person or object being monitored and collects data on the person or object, e.g., the motion state or orientation of the person or object. The sensor module 12 wirelessly communicates with nodes 11 to send the collected data to the central monitor 1. The nodes 11 are distributed at fixed known locations in a monitored premise 2 in which one or more persons or objects being monitored are located. The nodes 11 can be connected to the central monitor 1 either wirelessly or by cables. The communications between the nodes 11 and the central monitor 1 may be in a star configuration where each node 110 directly communicates with the central monitor 1 or in a mesh configuration where the nodes 11 communicate with each other and relay data from each node 11 to the central monitor 1 by hopping through other nodes 11.

The wireless sensor module 12 moves with the person or object within the premise 2 and its location can be determined by its distances to three different nodes 11, e.g., the nearest three nodes 11 at node locations A, B and C. This position processing can be done by, e.g., using the triangular geometry relations between the sensor module 120 and the three nearest nodes 11.

The positional information can be derived by dynamically adjusting the signal strength of the body mounted transceiver. By monotonically reducing the TX output power of the sensor module 12, the RF communications between a wireless sensor module 12 and fixed nodes 11 that are far away from the wireless sensor module 12 are lost, i.e., the signal strength is below a threshold level, at the beginning of the power reduction process and the wireless communications between the wireless sensor module 12 and the closest, fixed nodes 11 become lost last. This process can be used to identify the nearest nodes 111 around the sensor module 12 whose position is unknown and is to be determined. The positions of the last remaining nearest nodes 11 can be used to compute the centroid of these nodes to represent the approximate location of the sensor module 12. For example, two or three nearest nodes 11 may be used to determine the location of the sensor module 12. Therefore, this process provides an estimate of the actual position of the body mounted transceivers using the “last-lost” fixed transceivers in nodes 11 to estimate the location by a centroid approximation, which attempts to place the RF source in the geometric center of the “last-lost” transceivers.

In one implementation, the central monitor 1 can be used to perform the triangulation processing for determining the location of the sensor module 12. For example, an RF pilot tone signal can be broadcasted by the RF transceiver in the sensor module 12 and the detected signal strength of this RF pilot tone signal at nearby nodes 11 can be used to determine the position of the sensor module 12 within the premise 2.

The sensor in the sensor module 12 can include an accelerometer that measures accelerations along three orthogonal directions is referred to as a 3-axis accelerometer. In one implementation, the 3-axis accelerometer may include three accelerometers and each accelerometer is used to measure the acceleration along one of the three directions. The accelerometer may be an integrated Micro-Electro-Mechanical System (MEMS) accelerometer. The acceleration data can be used to determine the motion of a body part of a person or object. In one example, the motion of the waist of the person is monitored when the sensor module is attached to the person's waist and can be used to determine whether the person falls at a particular location. In another example, the sensor module may be attached to the person's chest to measure the motion of the chest in order to monitor the breathing of the person. The sensor in the sensor module 12 can also include a gyroscope inertial navigation system (INS) sensor to measure the orientation of the sensor module 12 and thus the orientation of the person.

In many applications, the sensor module 12 can include a combination of a tri-axial accelerometer and a gyroscope angular rate sensor to form an inertial measurement unit capable of determining the change in spatial orientation and linear translation (x, y, z) relative to a fixed external coordinate system. The gyroscope rate sensor, however, has a limited dynamic range (e.g., around or less than 25 MHz) and cannot measure high speed angular motion. A tri-axial magnetometer can be used to measure high speed angular motion based on the direction of the local magnetic field. Hence, the sensor module 12 may include a combination of the tri-axial accelerometer and tri-axial magnetometer without the need for the tri-axial gyros. More specifically, if the local magnetic field is constant over the extent of the spatial volume, the magnetometer can act as a differential gyro. This allows the magnetometer/accelerometer combination to act like a standard accelerometer/gyro inertial sensor in addition to the combo providing the initial start orientation. The magnetometer as a rate sensor has a singularity when the magnetic field is co-axial with one of the magnetic axes resulting in no magnetic component in the plane normal to the axes. This may not be a problem in most applications. If it is known that the body is not accelerating in any axis, the accelerometer becomes a gravitometer allowing the body orientation to be determined relative to the earth gravity field. The magnetometer determines the body orientation relative to the earth magnetic field. Combining this information allows determination of the absolute spatial orientation relative to the two external fields. It is desirable that there is no ferromagnetic material local to the magnetometer to avoid field distortion and subsequent orientation errors.

A tri-axial magnetometer can be further included used in conjunction with the tri-axial accelerometer, provides the capability to determine the absolute orientation of the sensor module 12, and the corresponding axis, relative to the local 1 g gravity vector and the local magnetic vector. Additionally, the magnetometer acts as a back-up rate sensor in case the gyro rate sensors saturate due to excessive rates of rotation or large acceleration induced gyro output errors. Therefore, in some applications, the gyro rate sensor and the magnetometer rate sensor can be combined to overcome the limitation of each individual sensor. Some examples of sensor designs for motion sensing are described in PCT Application No. PCT/US2006/05165 (publication No. 2006/088863) entitled “Single/Multiple Axes Six Degrees of Freedom (6 DOF) Inertial Motion Capture System with Initial Orientation Determination Capability” and U.S. Pat. No. 7,219,033, which are incorporated by reference as part of the specification of this application.

The motion sensing part of the sensor module 12 can be implemented in various configurations including the sensor configurations in ATTACHMENT 1 with 62 pages of text and 12 pages of figures, all attached here as part of the specification of this application. In applications which require a long battery life, the fall event can be detected with a MEMS accelerometer operated in a threshold mode. This mode allows the system to be powered down into a very low power state until a threshold event is detected by the accelerometer, i.e. free fall. This threshold can be used to initiate an external interrupt to the microcontroller to allow the full sensor complement to be quickly, a few milliseconds, powered to investigate the interrupt source to determine if indeed a fall event occurred and/or query the user audibly as to the need to call for assistance.

In the system 10 in FIG. 1, the nodes 11 at fixed locations form a wireless grid or network to provide wireless coverage over the premise 2 and a coordinate system to determine the position of the sensor module 12. The nodes 11 may be powered by the AC electrical power at the premise 2 or by a battery power supply in each node. The sensor module 12 is powered by a battery power supply and the RF transceiver can be a low power and narrowband transceiver to send the sensor data to the network of the nodes 11 which relay the sensor data to the central monitor 1.

In operation, the system 10 continuously monitors the position of a person or object with a sensor module on the premise 2. The central monitor 1 computes the position of the person or object and, when the person or object is outside the boundary of the premise 2, an alert signal is generated and a message may be sent to the person or object (e.g., an audio notification message).

The monitor system 10 in FIG. 1 may be configured for various monitoring applications. Examples for monitoring children, elderly and patients within a facility premise are described below.

### EXAMPLE 1

### Elderly Fall Monitor System

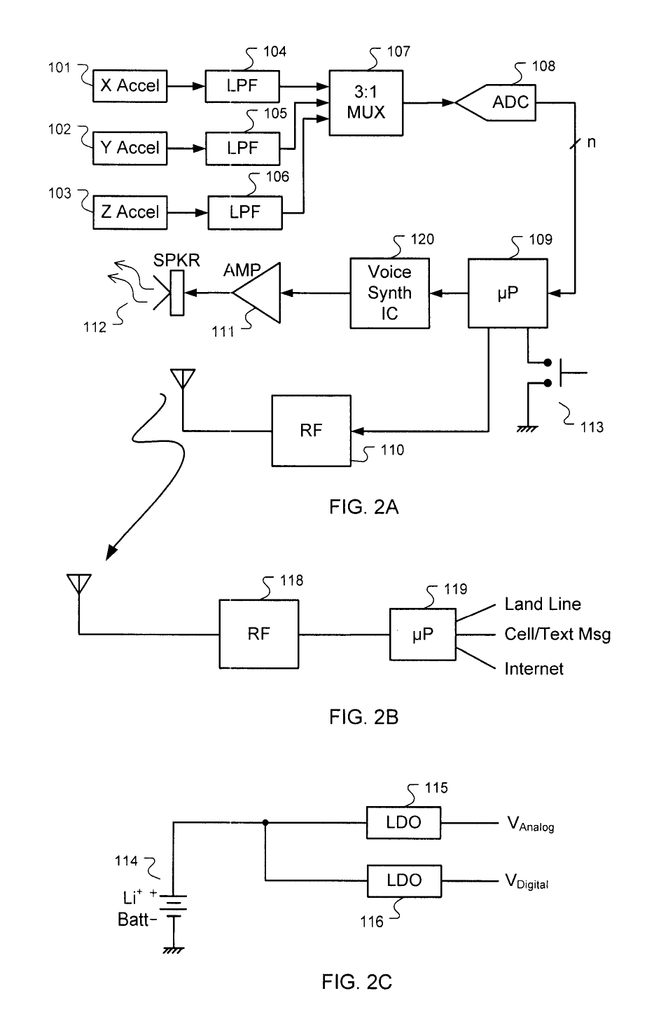

FIG. 2A shows one implementation of the sensor module 2 in FIG. 1 for monitoring a person such as a patient or an elderly person in a care facility equipped with a wireless grid with nodes 11 shown in FIG. 1. The sensor module in FIG. 2 can be mounted on the waist of the user so to be near the body center of mass. The position and motion of the sensor module in FIG. 2A can be used to monitor the center of mass of the person and to determine whether the person fails. If an impact and/or free-fall is detected on the waist, it is likely that the user has fallen. Additional sensor data may be included to further define a possible fall.

This waist mounted sensor module can include following components: 1) tri-axis accelerometer with three accelerometers 101, 102, 103 along three directions, 2) a low pass filter for each sensor output 104, 105, or 106, 3) 3×1 signal multiplexer 107 to combine the signals from the three accelerators into a sensor signal; 4) an analog to digital converter (ADC) 108 that converts the sensor signal from the signal multiplexer 107 into a digital signal (e.g., a 10 to 12 bit ADC); and 5) a micro-processor or micro-controller 109 (e.g., 8 to 32 bit processor) that processes the digital sensor signal from the ADC 108 for wireless transmission. In other implementations, three gyroscope sensors may be further included in the sensor module to sense the directions of the person and send the direction signal to the micro processor 109. The addition of extra motion sensors, i.e. tri-axial gyroscopes (117) and the associated filters and multiplexers, can improve the detection of potential falls by observing the full six degrees of freedom of the center of mass. The sensor module can use the microprocessor 109 for signal processing and for generating an audio signal to the user when an abnormal condition is detected, an audio amplifier 111 for amplifying the audio signal, and a speaker 112 for generating the sound of the audio signal. The sensor module in FIG. 2A also includes an RF transceiver/antenna 110 for wireless communications and a user pushbutton 113 for canceling an alert signal generated by the microprocessor 109 after the microprocessor 109 detects an abnormal condition of the user.

FIG. 2B shows one implementation of a wireless node 11 shown in FIG. 1. A node microprocessor or micro controller 119 is included in the node 11 to handle communications with the sensor module and the central monitor 1. The microprocessor 119 can include a communication interface to communicate with the central monitor 1 in FIG. 1 via one or more communication channels including the phone land line, cell phone or text message interface, the Internet or other computer network, and a local care-giver via a dedicated communication interface. The node 11 also includes an RF transceiver/antenna 118 for wirelessly communicating with at least a sensor module within the range of the node 11.

The sensor module on the user can be powered by a battery-based power supply. FIG. 2C shows one example of such a power supply which includes a Li-ion cell rechargeable battery or primary cell 114, a low drop-out (LDO) linear voltage regulator 115 for the analogy portion of the sensor module such as the sensors and RF transceiver circuit and a low drop-out (LDO) linear voltage regulator 116 for the digital part of the sensor module such as the micro processor 109.

A user sensor module can be operated at all times to monitor the motion of the user center of mass. The accelerometer (101, 102, 103) outputs can be filtered via the associated three low pass filters (104, 105, 106) to reduce the sensor bandwidth to that required to monitor the motion of the center of mass. The filtered output of the accelerometers can be multiplexed (107) to the analog to digital converter (108) to allow additional signal processing within the local microprocessor (109).

The user sensor module shown in FIG. 2A can include a learning mode for capturing the normal movement of the user and establishing a normal activity profile for the user. This learning mode is turned on prior to use of the unit in fall detection. In this learning mode, the microprocessor 109 monitors the normal sensor signals present in a non-fall environment. This allows an envelope of normal activities to be established. If a sensor signal falls outside this envelope, a fall event is likely and a user response request signal such as a voice message is generated to the user to request a user response. If the user doses not respond, an alert signal is subsequently generated by the microprocessor 109 and is sent to the central monitor 1 for assistance or further inspection. The user can cancel the alert signal by pressing the user pushbutton 113. In some implementations, the sensor data associated with a canceled alert signal can be added to update the normal envelope and to better estimate a fall event and minimize false fall event detection.

In operation, after the learning mode, the microprocessor 109 can be operated to continuously scan the incoming sensor data (e.g., the accelerometer data) and compare the sensor data to the normal envelope looking for the signature of a fall, i.e. a fast de-acceleration outside of the limits followed by no detectable motion for a specified period. Additionally, if the low power option using a MEMS accelerometer in threshold mode is used, the external interrupt can power up the full system to monitor the post-trigger condition of the user. If a deviation from the normal motion profile of the user is detected, an audible voice message can be generated by a voice synthesizer IC/amplifier/speaker (120, 111, 112) to alert the user and to request a user response. The audio message to the user may be to push the call/cancel button (113) within a time limit OR a distress call can be generated by the microprocessor 109 via the RF transceiver (110) to the node 11. Once the RF call is received by the node 11, the node 11 uses its RF transceiver (118) to generate a distress call to one or all of the following: a) phone land line, b) cell phone or text message interface, c) Internet, and d) local care-giver via dedicated communication interface.

If the user does not require assistance due to a fall or a false alert, the user can push the call/cancel button 113 within the time limit in response to the voice message to cancel the distress call. Additionally, if the user requires assistance for an unrelated problem, i.e. heart problems or illness, the call/cancel button 113 can be pushed anytime to generate a distress call. The distress call can include a code to determine if a fall or another cause is the source of the distress call.

To ensure for continuous monitoring, the microprocessor 109 may be controlled to continuously monitor the battery level. Once the level has reached a level requiring a battery change, an audible message will be generated to alert the user to recharge or replace the battery. A backup battery may be provided so the user can replace the depleted battery with the backup battery. A real-time clock can be integrated into the micro-processor software to put a time stamp on any generated distress calls and prevent a battery change message from being generated while the user is sleeping. The microprocessor 109 can determine if the battery level is sufficient to last the night, if not, the processor will request a battery change be:-ore the next sleep cycle.

### EXAMPLE 2

### Infant Monitor System

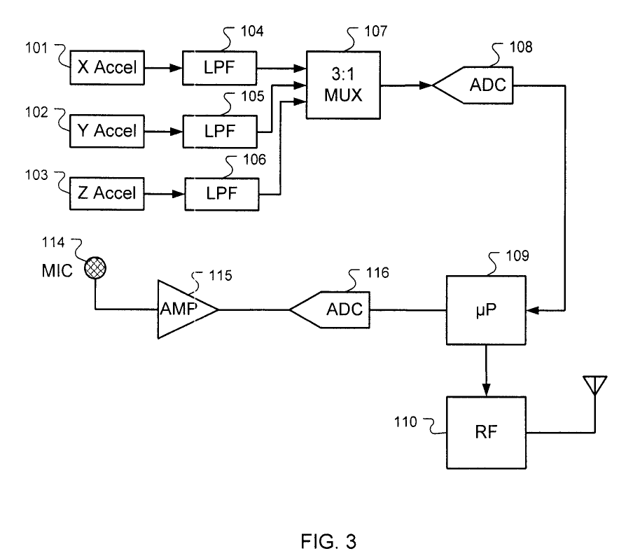

The system 10 in FIG. 1 may be specifically configured to monitor conditions of infants, e.g., sudden infant death syndromes. FIG. 3 shows an example sensor module for mounting on the stomach or chest area of an infant for monitoring the breathing activities. The processor 109 can be operated to analyze the accelerometer data via a variety of digital signal processing to extract the infant orientation, breathing rate, heart rate, skin temperature and crying, if present. The processor 109 can be programmed to include in each alert signal alert a code that identifies the cause of the alert, i.e. crying or breathing irregularities, to assist the determination of the severity of the problem and level of response needed.

The processor 109 can be first operated in a learning mode to “learn” the normal movement profile of the infant and then compares the captured sensor data with the “normal” condition profile to determine whether an abnormal condition is present. To extend the battery operating time, the sensor module may be operated in a low power mode and activated at a low duty cycle, e.g., to monitor the infant for 10 seconds every 30-60 seconds. If the infant is oriented in a non-desirable position, e.g., on the stomach, breathing is not detected, or the infant is crying, the processor 109 can be programmed to send an RF alert signal to a node 11 within the RF range. The node 11 is located within RF range of the infant mounted sensor unit. Similarly to the devices in FIGS. 2A-2C, the microprocessor 109 can be programmed to continuously monitor the battery level and can also include a clock to put a time stamp on any generated RF alerts.

The above sensor modules in FIGS. 2A-2C and 3 may also be implemented with a single node 11 without the network of nodes 11 shown in FIG. 1. After an alert signal is generated by the sensor module, the microprocessor 119 in the node 11 can be operated to generate a distress call to either or all the following: a) phone land line, b) cell phone or text message interface, c) Internet, and d) local care-giver via dedicated communication interface.

While this specification contains many specifics, these should not be construed as limitations on the scope of an invention that is claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications and enhancements to the described examples and implementations and other implementations may be made based on what is disclosed.

What is claimed is:

1. A sensor system, comprising:
a sensor module comprising a sensor attached to a person or object and operable to measure data of the person, a microprocessor operable to process the sensor data and to generate an alert signal when the sensor data indicates an abnormal condition of the person or object, and a wireless transceiver operable to wirelessly transmit the sensor data;
a network of wireless transceiver nodes distributed at fixed locations to receive the sensor data wirelessly transmitted by the sensor module; and
a central monitor in communication with the network of wireless transceiver nodes to communicate with the sensor module and operable to obtain a location of the sensor module based on signal strengths of a signal generated by the sensor module and received by a plurality of wireless transceiver nodes close to the sensor module.

2. The system as in claim 1, wherein the central monitor determines the location of the sensor module based on the signal strengths received by three wireless transceiver nodes closet to the sensor module.

3. The system as in claim 1, wherein the central monitor obtains a centroid position of wireless transceiver nodes that are closest to the sensor module as the location of the sensor module.

4. The system as in claim 1, wherein the sensor module comprises a motion sensor.

5. The system as in claim 4, wherein the motion sensor comprises an inertial measurement sensor.

6. The system as in claim 4, wherein the sensor module comprises a tri-axial accelerometer.

7. The system as in claim 6, wherein the sensor module comprises a tri-axial gyroscope rate sensor.

8. The system as in claim 4, wherein the sensor module comprises a tri-axial magnetometer and a tri-axial accelerometer.

9. The system as in claim 4, wherein the sensor module comprises a temperature sensor.

10. The system as in claim 4, wherein the sensor module comprises a gyroscope rate sensor and a tri-axial magnetometer.

11. The system as in claim 4, wherein the sensor module comprises a gyroscope rate sensor as a first rate sensor and a tri-axial magnetometer as a second rate sensor.

12. The system as in claim 1, wherein the sensor module comprises a user pushbutton to allow a user to generate a signal to the central monitor or to cancel a signal generated for the central monitor.

13. The system as in claim 1, wherein the sensor module comprises an audio circuit and a speaker that are operable collectively to produce an audio signal to the person when the sensor data indicates an abnormal condition of the person or object.

14. The system as in claim 1, wherein the central monitor stores data of a normal motion profile of the person or object and operates to compare motion data received from the sensor module to the normal motion profile to determine whether the motion data received from the sensor module deviates from the normal motion profile.

15. The system as in claim 1, wherein the central monitor generates an alert signal when the motion data received from the sensor module deviates from the normal motion profile.

16. A method for monitoring a person or object on a premise, comprising:
distributing wireless transceiver nodes at fixed locations on the premise;
attaching a user wireless transceiver to a person or object to wirelessly communicate with the wireless transceiver nodes;
obtaining a location of the person or object on the premise from signal strengths of a signal generated by the user wireless transceiver received at different wireless transceiver nodes;
attaching at least a motion sensor to the person or object to measure a motion of the person or object;
using the measured motion data from the motion sensor to detect whether the person or object has an abnormal motion; and
wirelessly transmitting an alert signal through the wireless transceiver nodes when an abnormal motion of the person or object is detected.

17. The method as in claim 16, comprising:
monotonically reducing transmission power of the sensor module to identify wireless transceiver nodes closest to the sensor module; and
using the location information of the wireless transceiver nodes closest to the sensor module to determine a location of the sensor module.

18. The method a sin claim 17, comprising:
using a centroid position of the wireless transceiver nodes closest to the sensor module as the location of the sensor module.

19. The method as in claim 16, comprising:
collecting motion data of the sensor module from the wireless transceiver nodes when the sensor module is at a normal motion mode to construct a normal motion profile of the sensor module;
comparing new motion data of the sensor module to the normal motion profile to determine whether the sensor module is in the abnormal motion.

20. The method as in claim 16, comprising:
comparing motion data of the sensor module to a normal motion profile for the sensor module to determine whether the motion data deviates from the motion profile to be in the abnormal motion.
